(19) United States
(12) Patent Application Publication
(10) Pub. No.: US 2012/0022840 A1
(43) Pub. Date: Jan. 26, 2012

(54) MODEL-BASED METHOD FOR ESTIMATING AN OPTIMAL TREATMENT DOSE FOR SEASONAL AFFECTIVE DISORDERS

(76) Inventor: Charles J. O'Neil, Southborough, MA (US)

(21) Appl. No.: 13/188,445

(22) Filed: Jul. 21, 2011

Related U.S. Application Data
(60) Provisional application No. 61/366,156, filed on Jul. 21, 2010.

(51) Int. Cl. G06F 17/10

(52) U.S. Cl. 703/2

(57) ABSTRACT

The invention is a model-based method for determining an approximate optimal dose of a psychiatric treatment, for any given latitude, date, and to be calibrated for an individual patient, for medical cases which have a seasonal aspect related to light exposure, in the sense that such treatment is best given in increasing amounts as either fall/winter or spring/summer approaches and in decreasing amounts as the season recedes.

### CROSS REFERENCE TO RELATED APPLICATION

The present application may include subject matter related to one or more of the following commonly-owned United States patent applications, each of which was filed on even date herewith, claims the benefit of, and is hereby incorporated herein by reference in its entirety: U.S. Provisional Application No. 61/366,156, filed Jul. 21, 2010.

### TECHNICAL FIELD

This invention relates to a method for determining an approximate optimal dose of a psychiatric treatment, for any given latitude, date, and individual patient, for medical cases which have a seasonal aspect.

### BACKGROUND

Some of the psychiatric disorders officially recognized by American Psychiatric Association (APA) as sometimes having a seasonal pattern include, but are not necessarily limited to, Major Depressive Disorder (MDD), Bipolar I Disorder, and Bipolar II Disorder. The seasonal pattern can be such that the condition is worse in fall/winter, meaning the period from the beginning of fall to the end of winter, or worse in spring/summer, meaning the period from the beginning of spring to the end of summer).

Winter Seasonal Affective Disorder, or Winter SAD fall/winter. Summer Seasonal Affective Disorder, or Summer SAD is a non-technical term for MDD with a seasonal pattern which is worse in spring/summer. A minimum criteria for a diagnosis of MDD with winter seasonal pattern is a history of MDD which is worse in fall/winter for two consecutive years and which cannot be explained by other factors.

About 20% of bipolar suffers have symptoms which fluctuate with the seasons. As of 2007 researchers have hypothesized that adjusting treatment dose according to season may be beneficial.

For sufferers of seasonal pattern depressive disorders who are taking medication the dose is often increased as the most troubling season approaches. Doses are typically increased when a symptom worsens. But it is not always easy to know exactly when to increase the dose or by how much to increase it. If done too soon then switching can cause discomfort associated with overdosing at the new dose. If the increase is too late then unnecessary suffering from under dosing will have occurred. After the worse season has passed, the problem arises as to when to decrease the dose and by how much.

An additional problem is that many drugs are in the form of solid tablets. Therefore the dose is not completely variable—the dose can only be increased easily by a whole pill, or by half a pill if the tablet has a score mark. A discovery that is part of this invention is that his can result in discomfort if a dose is not close enough to the optimum level. It may be too high or too low.

Seasonality can be missed completely, leaving the best direction of dose change confusing when discomfort is felt.

One reason that cases of seasonal disorders are not treated correctly is that the seasonality may not be known, suspected, or known for certain. In the development of this invention it has been learned that seasonality may not be recognized because it can be missed unless the doctor-patient team is charting symptom severity or dose strength over time,

Seasonality might also go unrecognized because it takes time to diagnose. According to APA guidelines, for a case to be considered to exhibit a seasonal pattern, at minimum there must be a two year history of symptoms worsening in either winter or summer, along with a lack of explanation for seasonality such as regular unemployment in the winter.

Yet another reason why seasonality may not be recognized is because diagnostic categories are evolving. Surprisingly, individuals with bipolar disorder experience greater seasonality than healthy people and depressives. Also, non-seasonal bipolar individuals, as a group, have the same degree of seasonal fluctuation as seasonal depressives as a group.

Yet another problem is that some disorders may not yet be widely recognized as potentially having a seasonal aspect such as Adult Attention Deficit Disorder, which was the subject of a study on effectiveness of light therapy. That study included a heterogeneous group of ADD patients (seasonal, nonseasonal; depressed, not depressed). The most responsive subgroup showed high seasonality of ADD regardless of seasonal mood variation.

It may be that some will disagree about whether dose increments available in the market are sufficiently small enough to avoid discomfort from over or under dosing. That, however is one point which this patent will address. It is be argued based on data obtained in developing the present invention that the available dose increments are too small. One argument for this position is that unsolved problems exist when taking anti depressants for major depression.

One unsolved problem addressed in this patent is that even when people are correctly diagnosed and taking psychiatric drugs many do not feel completely comfortable. About half the people who take antidepressants feel better on the drugs, yet many still have symptoms which are quite uncomfortable, including lack of sleep, difficulty thinking, and depressed mood. Furthermore, new symptoms arose after beginning antidepressants including insomnia and loss of interest level regarding activities. In a study of 428 people taking the antidepressant citalopram, 81 percent had insomnia in the middle of the night, 71 percent still experienced sadness, and 40 percent had a low interest in activities.

The presence of even mild symptoms is of concern because it portends future trouble in the form of social disability, faster relapse, and more chronic course. It correlates with future episodes of major depression even more than a history of multiple episodes.

Another unsolved problem addressed in this patent is that side effects of psychiatric drugs are significant. Of the people who prematurely discontinue treatment for depression, 23 percent did so because of adverse events, which include side effects.

### SUMMARY

The invention is a model-based method for determining an approximate optimal dose of a psychiatric treatment, for any given latitude, date, and to be calibrated for an individual patient, for medical cases which have a seasonal aspect related to light exposure, in the sense that such treatment is best given in increasing amounts as either fall/winter or spring/summer approaches and in decreasing amounts as the season recedes.

### BRIEF DESCRIPTION OF THE DRAWINGS

The invention description below refers to the accompanying drawings, of which:

FIG. 1 is a plot of Dose vs. Date for the Empirical Model for Sample Data-Worse in Winter

FIG. 2 is a plot of Dose vs. Date for the Empirical Model for Sample Data-Worse in Summer

FIG. 3 is a plot of Dose vs. Day Length showing a linear relationship

FIG. 4 is a diagram of Dose Prorating for Cases Worse in Winter-Full Year Dosing

FIG. 5 is a diagram of Dose Prorating for Cases Worse in Winter-Part Year Dosing

FIG. 6 is a diagram of Dose Prorating for Cases Worse in Summer-Full Year Dosing

FIG. 7 is a diagram of Dose Prorating for Cases Worse in Summer-Part Year Dosing

FIG. 8 is a plot of Dose vs. Date for a Calibrated Theoretical Model-Worse in Winter

### DETAILED DESCRIPTION

The present invention relates to a model-based estimation method of optimal treatment dose for cases of medical disorders which have a seasonal aspect related to light exposure in the sense that optimal treatment dose increases as either fall/winter or spring/summer approaches, then decreases as the season with worse symptoms recedes.

Embodiments of the invention span two different models—Empirical and Theoretical, which include different mathematical formulas depending on seasonality of disorder—worse in winter or worse in summer, and which include different mathematical formulas depending on whether a dose is taken for part of the year or for the full year.

The models are expected to work well only if the patient's exposure to light is regular enough. For example, the model can function poorly after the patient receives artificial light therapy such as 40 minutes per day of 10,000 lux light for about 4 weeks. The model can also function poorly if in a case of Winter SAD, the patient walks in the bright sunlight 45 minutes at a time, several times a week, for about 3 to 4 weeks.

Each model is a mathematical function, sometimes including mathematical sub-functions, which yields an approximate optimal dose, for any day of the year, when calibrated to fit the patient's treatment history, such history being in the form of dose data points. Each data point includes date, dose, and for enough of those data points, an indication of patient dose state. The dose state, most conveniently is one of three options, those options being over dosed, under dosed, and properly dosed, the latter meaning that there is a remarkable feeling of wellness.

If enough data points indicate properly dosed, and they cover a large enough span of day lengths then properly dosed is the only dose state option needed for calibration. If not, then it is sufficient to have data points which include two of the three options if enough are in each option category for an acceptable model accuracy.

The model has two main types, those types being Empirical and Theoretical. Both must be calibrated to fit treatment dose data points. The Theoretical model is also based on the discovery that when light exposure is regular enough, for at least some patients, optimal dose is very close to a linear function of day length.

The Empirical model dose is defined as being equal to either of two values, BaselineDose or CurveDose, whichever indicates the higher approximate optimal dose for the given point in time.

BaseLineDose is an approximate optimal dose equal to the lowest optimal treatment dose for the year, in cases where such a dose remains the same for more than one point in time. It is set to zero for cases where a treatment dose is taken for only a portion of the year. It can, however, be set to a number greater than zero.

CurveDose is the approximate optimal dose during the part of the year when the approximate optimal dose is not constant but varies, and is defined by

CurveDose=Trough+(Peak−Trough)×cos(FractionOfYear×2×pi+PhaseAngle)

where
Trough=the lowest point of the CurveDose function
Peak=the highest point of the CurveDose function
PhaseAngle=a value which indicates in which season the CurveDose needs to be highest
FractionOfYear=the fraction of the year which has passed since the most recent winter solstice, although it can be the fraction since any winter solstice since cos is a periodic trigonometric function,
where

FractionOfYear is defined as

FractionOfYear=DaysBeyondRefSolstice/365.2422−trunc(DaysBeyondRefSolstice/365.2422))*365.2422

where

trunc( )is a function which truncates it's argument, in that it subtracts the fractional part of the argument from the argument

DaysBeyondRefSolstice=CalendarDate−date(1995,12,21)

where
CalendarDate is the serial number of the date of a point during the year,
which follows the convention that the serial number of Jan. 1, 1900 is 1,
date( )is a function which provides the date serial number of it's argument and follows the convention that date(1900,1,1)=1

In the general case, the CurveDose equation is calibrated by

### Step 1

setting PhaseAngle to 0 if CurveDose peaks on or near the December Solstice,
setting PhaseAngle to pi, approximately 3.14159, if CurveDose peaks on or near the June Solstice,

### Step 2

setting Peak to the approximate maximum optimal dose during the year,
setting Trough to whatever value is needed, (sometimes to a negative number for partial year dosing and typically to the minimum optimal dose for full year dosing), to position CurveDose, on a plot of dose vs. date, in such a way as to overlay, or come close to
a) as many properly dosed data points as possible,
b) the area where the over dosed and under dosed data points meet each other, overlap, or come closest, or
c) the area where the over dosed and properly dosed data points meet each other, overlap, or come closest, or
d) the area where the properly dosed and under dosed data points meet each other, overlap, or come closest, or
e) any combination of the above criteria

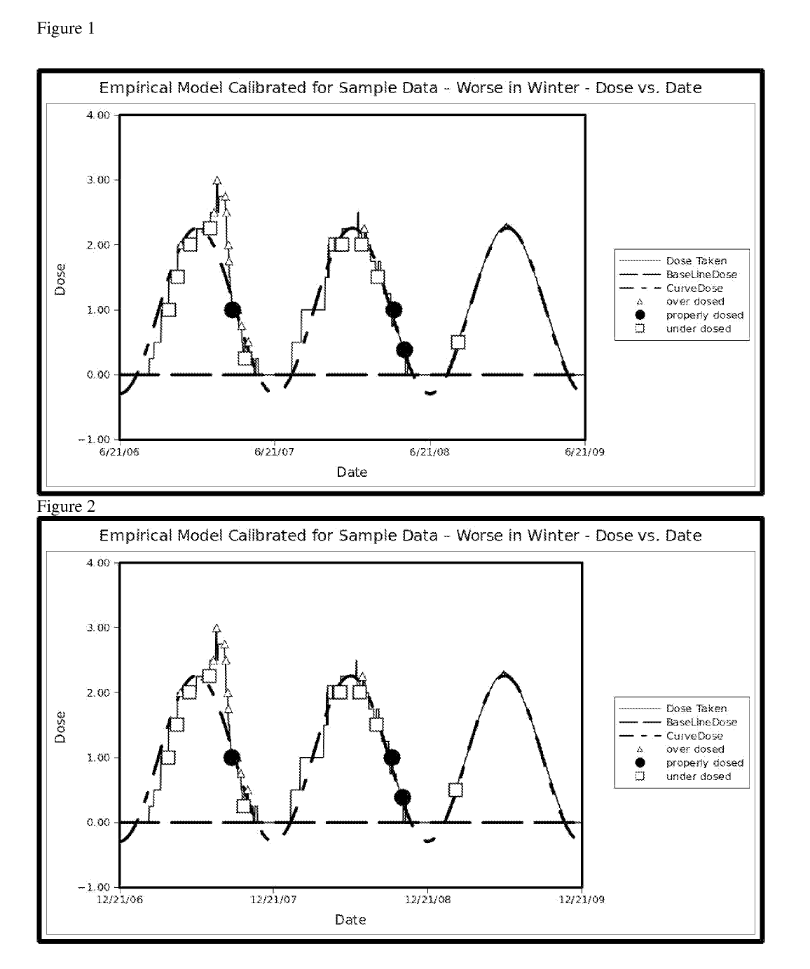

An example of an Empirical model calibrated for data for a case of a disorder which is worse in winter is shown in FIG. 1, along with the dose history data points with some labeled according to dose status.

An example of a Empirical model calibrated for data for a case of a disorder which is worse in summer is shown in FIG. 2, along with the dose history data points with some labeled according to dose status.

It can be quite difficult to figure out what dose should be taken on a given day without knowing what symptoms to use as a guide or without having the benefit of a model. Dose data like that in FIG. 1 during the first twelve months can be the result of that difficulty. The dose taken can be far from optimal for much of the time. It is only after plotting data points on a graph that a better idea of what may be optimal emerges.

One part of this invention is the discovery that optimal dose can be predicted using only one trigonometric function in an otherwise linear equation like the one given for the Empirical model. With experience it was discovered that a significant improvement can be achieved regarding symptoms of under dosing and side effects from over dosing by following a well calibrated Empirical model to within one quarter of a 15 mg mirtazapine tablet. The model becomes easier to calibrate once several solstices pass and experience provides knowing of optimal doses at the solstices.

One discovery is that vivid dreams correlate with dosing above the model value. It was also discovered that a tired but too wired to sleep feeling also correlated with being above the model value. It was learned that even slight drops in self esteem correlate with being below the model dose.

The ability to use finer increments of dosing, and the ability to calibrate the model better, combine to form a virtuous cycle. As the model calibration becomes better, and as dosing precision becomes finer, subtle deviations from the model become noticeable. They, in turn, can be used to further fine tune the model.

Optimal dose is found to follow a calibrated sinusoidal function, of the simplicity of the CurveDose, shape closely enough to make a difference in quality of life. It is known that day length also follows a classic sinusoidal shape fairly closely. That has led to the discovery included in this invention that a theoretical model can be made based on prorating dose according to day length. Such a model is an improvement over the Empirical model, when day length is calculated precisely using a public domain equation for day length, which involves more than one trigonometric function.

However, even when well calibrated, a model of the complexity of the CurveDose equation was found to yield optimal doses which were inferior to that from the Theoretical model discussed later in this description. The simpler model was up to 3% below the Theoretical model optimal doses in the spring and summer, and up to 9% above the Theoretical model optimal doses in the fall and winter. Such differences are significant because a well trained patient can feel properly dosed when taking doses consistently within 2% (0.3 mg) of a 15 mg mirtazapine optimal dose supplied by the Theoretical model, but feel discomfort when taking, for more than a few days, a dose which is 6% (0.9 mg) higher than a 15 mg mirtazapine optimal dose supplied by the Theoretical model.

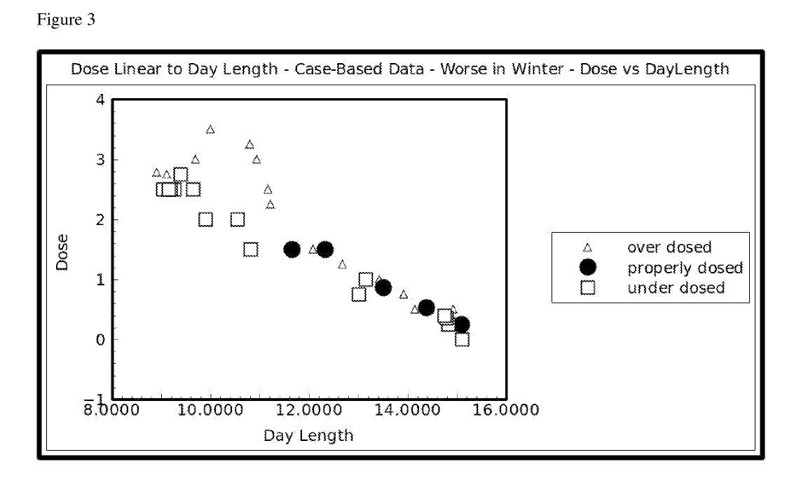

FIG. 3 shows the very good linear correlation between optimal dose and day length. In FIG. 3. the degree to which the left most circle representing a “just right” (in other words “properly dosed”) state, is out of line can be explained by an extraordinary amount of exposure to outdoor light on or near the date of that data point. In FIG. 3, a straight best-fit optimal dose vs day length line can be drawn in the region between the under and over dose points, which is also close to the best fit line using only properly dosed data points.

The plot in FIG. 3 suggests that when patients are less in need of light exposure the best-fit line will be lower than the one in FIG. 3 and possibly of a different angle for each patient, latitude, and treatment. If it is low enough it will intersect a line defined by dose=zero (the day length axis in the graph shown) within the range of day lengths between the summer and winter solstices for the given latitude. In that case doses would be optimally taken for only part of the year.

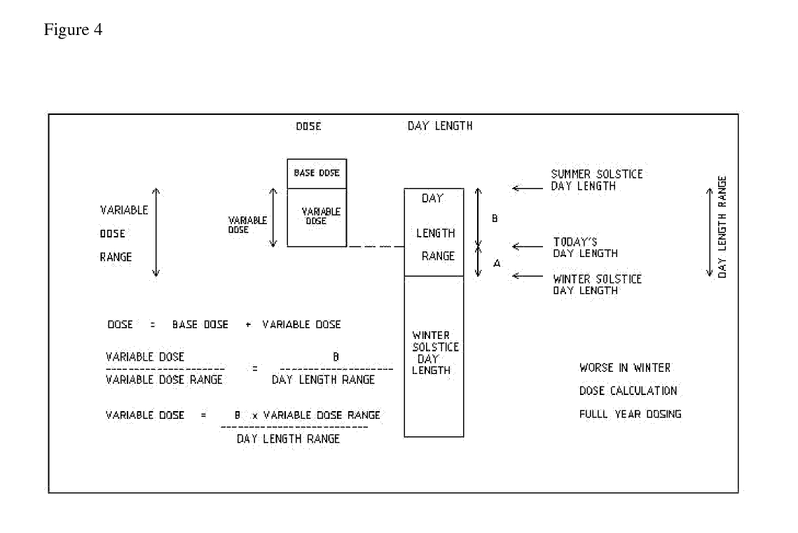

The Theoretical mathematical model included in this invention is based on the principle that for a patient with light exposure which is regular enough, optimal dose is a linear function of day length. The Theoretical model has four forms, each named for the season in which the disorder is worse and for how much of the year a dose is taken. The forms are Worse in Winter-Full Year, Worse in Winter-Part Year, Worse in Summer-Full Year, and Worse in Summer-Part Year. They are defined below and are illustrated in FIGS. 4 through 7.

For the Theoretical model Worse in Winter-Full Year form, FIG. 4 shows how the principle of dose prorating by day length is used to produce a mathematical equation for disorders that are worse in winter, and in which dosing is year round. One bar is shown which represents the day length at the winter solstice. On top of it sits another bar which represents the variable part of the day length. A base dose is represented by another bar whose bottom edge is at the height of the summer solstice. The base dose bar is needed because for full year dosing, for some cases, a certain dose is required even at the summer solstice. Below the base dose bar is a bar for the variable part of treatment dose. The upper edge of the variable dose bar is fixed in position. The lower edge of the variable dose bar is connected by a dashed line to, and aligned with the current day which is referred to as Today's Day Length to indicate that conceptually its position moves up and down as the days pass. An arrow indicates today's day length which corresponds to the date for which the dose is calculated.

Prorating is performed in such a way that in FIG. 4 the ratio of variable dose to variable dose range equals the ratio of B to the day length range, where B is the difference between the summer solstice day length and the current day length. Following the equations in FIG. 4 but substituting slightly different names, and expanding on some terms,

$$Dose = Base Dose + Variable Dose$$

$$\frac{VariableDose}{VariableDoseRange} = \frac{( SummerSolsticeDayLength - CurrentDayLength )}{DayLengthRange}$$

$$VariableDose = ( ( SummerSolsticeDayLength - CurrentDayLength ) … \times VariableDoseRange ) / DayLengthRange$$

The terms in the equation are described as follows along with some terms to be used in subsequent equations

Dose is the optimal dose for any given point in time
BaseDose is the lowest optimal dose during any year
VariableDose is the portion of the optimal dose which varies during the year
CurrentDayLength is the length of the current day, also described as the length of the day of interest, length of the day for which the dose is to be determined, or Today's Day Length
SummerSolsticeDayLength is the length of the day at the summer solstice
WinterSolsticeDayLength is the length of the day at the winter solstice
HighestOptimalDose is the highest optimal dose of the year
LowestOptimalDose is the lowest optimal dose during the year
VariableDoseRange is the range of VariableDose throughout the year and is defined as

VariableDoseRange=HighestOptimalDose−LowestOptimalDose

DayLengthRange is the range of the length of days in the year, also specified as the difference between the day length at the summer solstice and the day length at the winter solstice and is defined by

DayLengthRange=SummerSolsticeDayLength−WinterSolsticeDayLength.

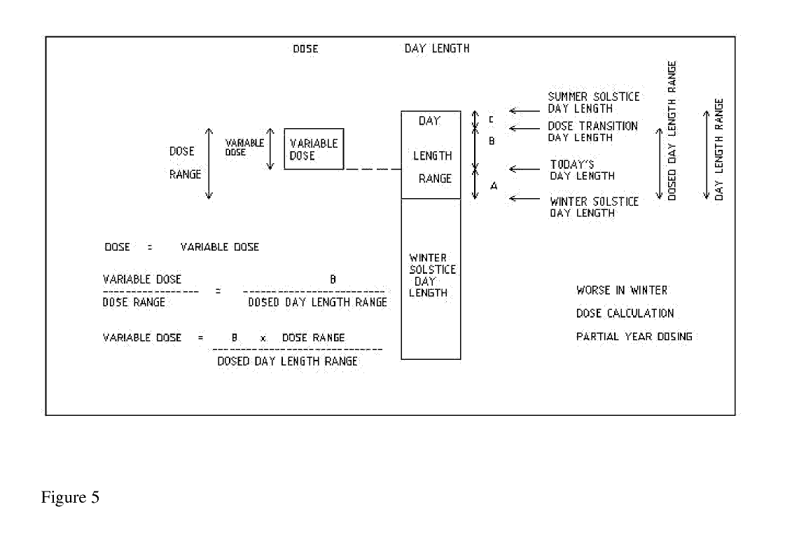

For the Theoretical model Worse in Winter-Part Year form, FIG. 5 shows how the principle of dose prorating by day length is used to produce a mathematical equation for disorders that are worse in winter, and in which dosing is for only part of the year. It is similar to the case where dosing is year round. However, in this case there is no base dose. Also, the date of a transition between the point of no dose and when a dose is taken is termed the transition day length and is shown with an arrow at the same height as the fixed upper edge of the variable dose bar. Again, the bottom edge of the variable dose bar is imagined to move up and down as the year progresses. A dashed line at the lower edge of the variable dose bar indicates a link to the current date partly for the purpose of implying change in position over time.

Prorating is done in such a way that the ratio of variable dose to variable dose range equals the ratio of B to dosed day length range, where B is the difference between the transition day length and the current day length. Following the equations in FIG. 5 but substituting slightly different names, and expanding on some terms,

$$\frac{VariableDose}{VariableDoseRange} = \frac{( TransitionDayLength - CurrentDayLength )}{DosedDayLengthRange}$$

or, after placing only the Variable Dose on the left hand side,

VariableDose=((TransitionDayLength−CurrentDayLength) . . . . . . ×VariableDoseRange)/DosedDayLengthRange

for which some terms are described previously, and for which

TransitionDayLength is the day length at the time of year when the optimal dose starts to be greater than the lowest dose of the year,

and for which the following term(s), which may vary depending on the form of the Theoretical model to be used, are also described

DosedDayLengthRange is the difference between the day length at the time of year when the optimal starts to be greater than the lowest dose of the year, and the day length at the winter solstice and is defined by

Do sedDayLengthRange=TransitionDayLength−WinterSolsticeDayLength.

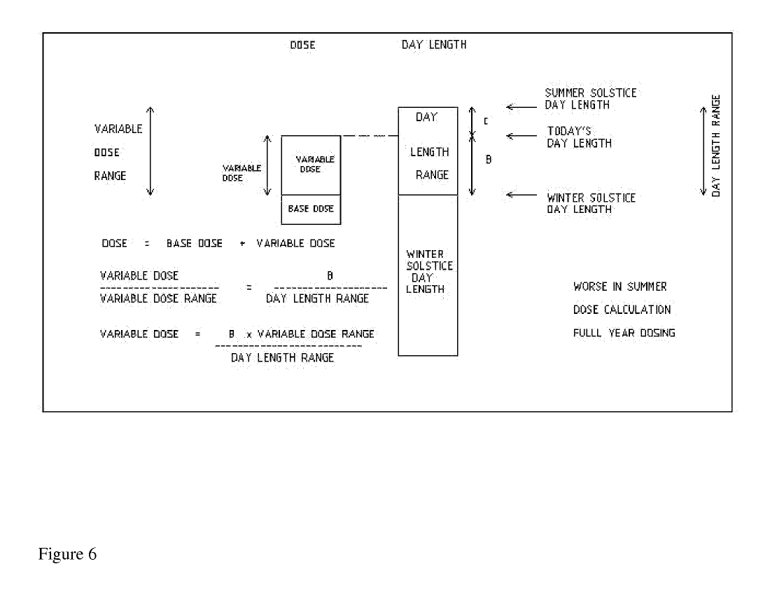

For the Theoretical model Worse in Summer-Full Year form, FIG. 6 shows how the principle of dose prorating by day length is used to produce a mathematical equation for disorders that are worse in summer, and in which dosing is year round. One bar is shown which represents the day length at the winter solstice. On top of it sits another bar which represents the variable part of the day length. A base dose is represented by another bar. The base dose bar is needed because for full year dosing, for some cases, a certain dose may be required even at the winter solstice. Above it is a bar for the variable part of treatment dose. The bottom edge of the variable dose bar is fixed and is aligned with the day length of the winter solstice. An arrow indicates the winter solstice day length. The upper edge of the variable dose bar is aligned with the day length of the current date, referred to as Today's Day Length. An arrow indicates Today's Day Length. That upper edge of the variable dose bar conceptually moves up and down as day lengths change. A dashed line at the upper edge of the variable dose bar indicates a link to the current date.

Prorating is done in such a way that the ratio of variable dose to variable dose range equals the ratio of B to day length range, where B is the difference between the current day length and the winter solstice day length. Following the equations in FIG. 6 but substituting slightly different names, and expanding on some terms,

$$Dose = Base Dose + Variable Dose$$

$$\frac{VariableDose}{VariableDoseRange} = \frac{( CurrentDayLength - WinterSolsticeDayLength )}{DayLengthRange}$$

$$VariableDose = ( ( CurrentDayLength - WinterSolsticeDayLength ) … \times VariableDoseRange ) / DayLengthRange$$

in which terms have been described above

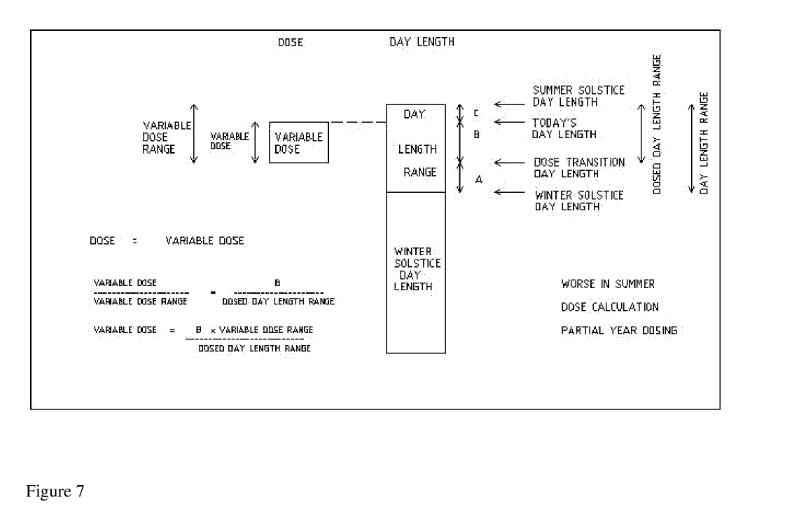

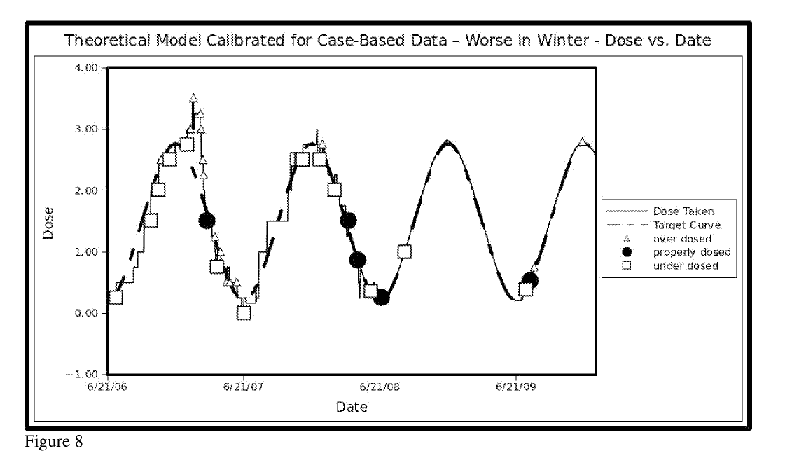

For the Theoretical model Worse in Summer-Part Year form, FIG. 7 shows how the principle of dose prorating by day length is used to produce a mathematical equation for disorders that are worse in winter, and in which dosing is for only part of the year. It is similar to the case where dosing is year round. However, in this case there is no base dose. Also, the date of a transition between the point of no dose and when a dose is taken is termed the transition day length and is shown with an arrow at the same height as the fixed lower edge of the variable dose bar. Again, the upper edge of the variable dose bar is imagined to move up and down as the year progresses. A dashed line at the upper edge of the variable dose bar indicates a link to the current date.

Prorating is done in such a way that the ratio of variable dose to variable dose range equals the ratio of B to dosed day length range, where B is the difference between the current day length and the transition day length. Following the equations in FIG. 7 but substituting slightly different names, and expanding on some terms,

$$\frac{VariableDose}{VariableDoseRange} = \frac{( CurrentDayLength - TransitionDayLength )}{DosedDayLengthRange}$$

$$VariableDose = ( ( CurrentDayLength - TransitionDayLength ) … \times VariableDoseRange ) / DosedDayLengthRange$$

for which these term(s), which may vary depending on the form of the Theoretical model to be used, are also described.

DosedDayLengthRange is the difference between the day length at the summer solstice, and the day length at the time of year when the optimal dose starts to be greater than the lowest dose of the year and is defined by

DosedDayLengthRange=SummerSolsticeDayLength−TransitionDayLength.

For all four forms of the Theoretical model which are defined above, day lengths are calculated for each day for a given latitude. One equation which calculates day length, the components of which are described in the public domain, is used in the Theoretical model and is defined as

DayLength=24×(a cos(1−(1−tan(Latitude)×tan(Obliquity×cos(ConstantJ×DayOfSolarYear))))/pi( ))

where
a cos( )is the trigonometric function arccosine
tan( )is the trigonometric function tangent

Latitude is the earthly latitude where the patient lives, in radians, which must be entered as a positive in the northern hemisphere and negative in the southern hemisphere

Obliquity is, for practical purposes, a constant equal to 0.4090877 radians and is the angular difference between the earth's polar axis and a line passing through the center of the earth, such line oriented orthogonally to the plane of the earth's orbit about the sun

ConstantJ is, for practical purposes, a constant pre-calculated as 0.01720242383896, and equal to pi divided by an approximation of half the average number of days in a year, 182.625

DayOfSolarYear is the number of days from any winter solstice in the northern hemisphere (regardless of in which hemisphere the day length is being sought, so long as the sign of the latitude follows the convention above), but for which Dec. 21, 1995 is used for practical purposes in the present model

for which it is useful to define date( )as a function which provides the date serial number and takes the form date(Y,M,D)
where
Y is the year,
M is the month, and
D is the day of the month
and follows the convention that date(1900,1,1)=1.

So that TransitionDayLength, SummerSolsticeDayLength, and WinterSolsticeDayLength need only be calculated once, and because those two day lengths will be very nearly the same from year to year for a given Latitude, the DayLength function is adapted and becomes

TransitionDayLength=24×(a cos(1−(1−tan(Latitude)×tan(Obliquity×cos(ConstantJ×(date(1995,TransitionDateM,TransitionDateD)−date(1995,12,21))))))/pi( )

where
TransitionDate is a date on which the optimal dose starts to rise above BaseLineDose,
TransitionDateM is the month of TransitionDate
TransitionDateD is the day of the month of TransitionDate
and

SummerSolsticeDayLength=24×(a cos(1−(1−tan(Latitude)×tan(Obliquity×cos(ConstantJ×(date(1995,SummerSolsticeDateM,SummerSolsticeDateD)−date(1995,12,21))))))/pi( )

where
SummerSolsticeDate is the approximate date on which the summer solstice falls for the earthly latitude where the patient lives
SummerSolsticeDateM is the month of the summer solstice for the latitude where the patient lives
SummerSolsticeDateD is the day of the month of the summer solstice for the latitude where the patient lives, ‘
and

WinterSolsticeDayLength=24×(a cos(1−(1−tan(Latitude)×tan(Obliquity×cos(ConstantJ×(date(1995,WinterSolsticeDateM,WinterSolsticeDateD)−date(1995,12,21))))))/pi( )

where
WinterSolsticeDate is the approximate date on which the winter solstice falls for the earthly latitude where the patient lives
WinterSolsticeDateM is the month of the winter solstice for the latitude where the patient lives
WinterSolsticeDateD is the day of the month of the winter solstice for the latitude where the patient lives, which is set to 21 here for practical purposes
and

CurrentDayLength=24×(a cos(1−(1−tan(Latitude)×tan(Obliquity×cos(ConstantJ×(CurrentDate−date(1995,12,21)))))))/pi( )

where

CurrentDate is the current date of the point in time of interest, expressed as a date serial number using the convention that the serial number for Jan. 1, 1900 is equal to 1, and which is used to calculate CurrentDayLength

The focus is now switched away from the Theoretical model and back to the Empirical model. There are a number of methods by which the Empirical model may be calibrated, in the sense of producing the best fit of the model to the data points. Those methods include but may not be limited to flat-line, peak-and-trough, and two-stair-step. For purposes of calibrating a model, dose status, also referred to as dose state, is defined as a condition felt by a patient which is that of feeling either under dosed, properly dosed, or overdosed. It is expected that for different patients the signs of dose state will be different, and that they might only be learned with experience.

The flat-line calibration method is the most general method in that it may be used for any situation in which the Empirical model is used. It does not require that the Empirical model optimal dose stay at its lowest value for only one day at a time, as the peak-and-trough calibration method requires.

The flat-line calibration method is used with the Empirical model by performing the following steps.

### Step 1

Plotting dose taken against point in time, including the showing of distinguishing symbols for different dose statuses for a number of data points,

Step 2

Setting Peak, Trough, and BaseLineDose in the model equation to the values needed to position the Empirical model dose on a plot of dose vs. point in time, in such a way as to overlay, or come close to
a) as many properly dosed data points as possible, or
b) the area where the over dosed and under dosed data points meet each other, overlap, or come closest, or
c) the area where the over dosed and properly dosed data points meet each other, overlap, or come closest, or
d) the area where the properly dosed and under dosed data points meet each other, overlap, or come closest, or
e) any combination of the above criteria

The peak-and-trough calibration method may be used with the Empirical model when the optimal dose varies continuously over time—that it stays at it's lowest value for only one point in time. Such is the case when the CurveDose is always greater than the BaseLineDose, making the BaseLineDose irrelevant, so that all that is needed is to calculate the optimal dose is to know the Peak and Trough values. Because only one to three decimal places of a dose may be visible, an optimal dose may appear to stay at one level for more than one day at a time, when in fact it does not.

The peak-and-trough calibration method is used with the Empirical model by performing the following steps.

### Step 1

Plotting dose taken against point in time, including the showing of different symbols for different dose statuses for a number of data points,

### Step 2

Setting Peak and Trough in the model equation to the values needed to position the Empirical model dose on a plot of dose vs. point in time, in such a way as to overlay, or come close to

a) as many properly dosed data points as possible, or
b) the area where the over dosed and under dosed data points meet each other, overlap, or come closest, or
c) the area where the over dosed and properly dosed data points meet each other, overlap, or come closest, or
d) the area where the properly dosed and under dosed data points meet each other, overlap, or come closest, or
e) any combination of the above criteria.

Regardless of whether the Empirical or Theoretical model is used, it is important to calibrate the model as quickly as possible.

A properly dosed data point provides a better target for calibration than the other states. When two properly dosed data points are found, that is sometimes enough information to calibrate either the Empirical or Theoretical model. The information is enough when there is confidence that they are truly properly dosed points, meaning in part, that no extraordinary exposure to light could have made them appear to be properly dosed in the general sense, and when they are far enough apart in day length, for the model to be calibrated well.

Included in this invention is a two-stair-step method which can sometimes speed up calibration by making it easier to discover data points with properly dosed status.

To understand the two-stair-step method, an analogy is useful. A plot of dose vs. time, with the sequential dose data points connected by a line, will often resemble a stairway if a treatment dose is kept at the same level for a long enough period of time, then subsequently changed to another level and kept at that level for a long enough period of time, and so on. As the time of year approaches when the disorder is worse then the stairway will generally be ascending. As the worse time of year recedes into the past, the stairway will generally be descending.

If one is fortunate enough, a dose, held constant for long enough, may eventually come to be very close to the optimal dose for a moment in time. During that moment a feeling of remarkable wellness can often be felt. That can be a state of being properly dosed. At that point, to use the stairway analogy, the horizontal part, sometimes called the runner of the step on the stairway, may have intersected the curve of optimal dose, the location of which is the goal of the Empirical and Theoretical models.

It should be noted that a properly dosed status, with its remarkable feeling of well being can also occur soon after a dose change. One should be aware that such a situation may be the result of the stairway step riser, the vertical part of the stairway, having crossed an optimal dose curve whose location may not yet have been discovered. The feeling of wellness may be the result of an averaging of the current dose and the previous dose. Therefore, for a dose and it's point in time to be confidently considered to be a useful point of properly dosed status, it should be at a time far enough away from the beginning of the dose step. For example, confidence is increased if the time which has passed from the most recent dose change is more than about 6 half lives of the drug concentration in the blood.

The two-stair-step method suggests a way in which properly dosed data points can sometimes be found. That way is to be on the lookout for points in time when the patient feels remarkably well, so that the model can be quickly calibrated.

There are a number of methods by which the Theoretical model may be calibrated, in the sense of producing the best fit of the model to the data points. Those methods include but may not be limited to four methods which are named general, high-low, dose-daylength, and two-stair-step.

The general calibration method may be used for any situation in which the Theoretical model is used. It does not require that the Theoretical model optimal dose stay at it's lowest value for only one point in time, or day at a time.

The general calibration method is used with the Theoretical model by performing the following steps.

### Step 1

plotting dose taken against point in time, including the showing of different symbols for different dose states for a number of data points,

### Step 2

determining which of the four forms of the model are appropriate for the patient's case,

### Step 3

setting Latitude in the model equations to the earthly latitude where the patient lives, being sure to set latitude to a positive number for locations in the northern hemisphere and to a negative number for locations in the southern hemisphere.

### Step 4

Setting HighestOptimalDose, LowestOptimalDose, and TransitionDayM, and TransitionDayLengthD in the model equations to the values needed to position the Theoretical model optimal dose on a plot of dose vs. point in time, in such a way as to overlay, or come close to
a) as many properly dosed data points as possible, or
b) the area where the over dosed and under dosed data points meet each other, overlap, or come closest, or
c) the area where the over dosed and properly dosed data points meet each other, overlap, or come closest, or
d) the area where the properly dosed and under dosed data points meet each other, overlap, or come closest, or
e) any combination of the above criteria

The high-low calibration method is appropriate for the Theoretical model when optimal dose stays at its lowest value for only one point in time, usually one day. That is to say that it is appropriate when the optimal dose varies continuously, in the strictest mathematical sense, throughout the entire year. It can be used when LowestOptimalDose, the lowest optimal dose, is zero or greater than zero.

The high-low calibration method is used with the Theoretical model by performing the following steps.

### Step 1

plotting dose taken against point in time, including the showing of different symbols for different dose statuses for a number of data points, and

### Step 2

determining which of the four forms of the model are appropriate for the patient's case, using either the Worse in Winter-Full Year form or the Worse in Winter-Full Year form.

### Step 3

setting Latitude in the model equations to the earthly latitude where the patient lives, being sure to set latitude to a positive number for locations in the northern hemisphere and to a negative number for locations in the southern hemisphere.
Setting TransitionDayM in the model equation to the 6 if the disorder is worse in December,
Setting TransitionDayM in the model equation to the 12 if the disorder is worse in or close to June, and
setting TransitionDayLengthD in the model equation to 21

### Step 4

Setting HighestOptimalDose and LowestOptimalDose in the model equation to the values needed to position the Theoretical model dose on a plot of dose vs. point in time, in such a way as to overlay, or come close to
a) as many properly dosed data points as possible, or
b) the area where the over dosed and under dosed data points meet each other, overlap, or come closest, or
c) the area where the over dosed and properly dosed data points meet each other, overlap, or come closest, or
d) the area where the properly dosed and under dosed data points meet each other, overlap, or come closest, or
e) any combination of the above criteria

The dose-daylength calibration method can be one of the quickest ways to calibrate the Theoretical model for the entire year. The dose-daylength method is based on the principle that, and useful in cases where, optimal dose is a linear function of day length.

When data points of dose are plotted against day length, if enough data points are shown, there can emerge a fairly clear picture of where a best-fit straight line would be. In other words the best-fit line is drawn to indicate the position where properly dosed points would lie for each possible value of day length.

When that best-fit line is extrapolated out beyond its upper end, to the day length of the solstice during the part of the year when the disorder is worse, it will indicate a dose value which is an approximation of the optimal dose at that solstice. That dose value can be used to set the Peak when calibrating the Theoretical model.

When this method can be useful, a best-fit straight line can be extrapolated beyond its lower dose end. If so, it will either reveal a dose at the day length of the solstice for which the disorder is not worse, or will reveal a day length at which the dose is zero. The dose at the day length of the solstice for which the disorder is not worse, if a positive value, is used to set the lowest dose for the year. The day length where the dose is zero, in the case where that day length is between that of the two solstice day lengths, is used to determine a month and day of the month of the transition date, the date at which the optimal dose just begins to increase above its lowest point.

Within the dose-daylength calibration method is a method for determining the best-fit line for dose plotted against daylength. The best-fit method consists of the following steps.

### Step 1

Plotting dose taken against day length, including at least some symbols which indicate which points have which dose states.

### Step 2

Positioning the best-fit line in such a way as to overlay, or come close to

a) as many properly dosed data points as possible, or
b) the area where the over dosed and under dosed data points meet each other, overlap, or come closest, or
c) the area where the over dosed and properly dosed data points meet each other, overlap, or come closest, or
d) the area where the properly dosed and under dosed data points meet each other, overlap, or come closest, or
e) any combination of the above criteria.

The dose-daylength calibration method is used with the Theoretical model by performing the following steps.

### Step 1

using the best-fit method described above

### Step 2

Determining which of the four forms of the model are appropriate for the patient's case.

### Step 3

setting Latitude in the Theoretical model equation (s) to the earthly latitude where the patient lives,

### Step 4

Setting HighestOptimalDose in the model equation (s) to the dose value of the best-fit line at the point where daylength equals that of the solstice in which the disorder is worse

### Step 5

setting the LowestOptimalDose in the model equation (s) to zero if the lower end of the best-fit line extrapolates to a day length where dose equals zero if that daylength lies in between the day lengths of both solstices; and if both conditions are true, using that day length and the DayLength equation to determine, by trial and error, a month and day for the transition point; then setting the TransitionDayM and TransitionDayMin the model equation (s) to those moths and days

### Step 6

if the best-fit line has a positive dose value where daylength equals that of the solstice for which the disorder is not worse, setting the LowestOptimalDose to that dose value, and setting TransitionDayM in the model equation to the 6 if the disorder is worse in December, Setting TransitionDayM in the model equation (s) to the 12 if the disorder is worse in or close to June, and setting TransitionDayLengthD in the model equation (s) to 21

One advantage of the dose-daylength calibration method is that by using it, only two properly dosed data points are necessary to provide a calibration for the entire year. Another advantage is that calibrating a plotted linear function by eye can be easier than for a sinusoidally shaped function because it is easier to site along a straight line. It also may be easier to judge precision by seeing how well the line fits the data, which provides a sense of how precisely the predictions from the line can be known. This method can provide the Theoretical model with all three pieces of information needed (except for the latitude which is determined by other means)—the highest and lowest doses for the entire year, as well as the transition point. An advantage is that a good handle on calibration might be obtained without passing through solstices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A model-based method for estimating an optimal treatment dose for any point in time, for a case of a medical disorder, for which such case has a seasonal aspect in the sense that symptoms of the disorder are worse in either fall/winter or spring/summer, comprising:
supplying the model with data concerning the dose history of the case of the disorder;
calibrating the model to fit the data; and
using the calibrated model to calculate an optimal treatment dose for the point in time of interest.

2. The method of claim 1 in which the model is an empirical model, and for which the case has a seasonal aspect which is also related to current light exposure or history of light exposure, and for which such case has a decrease in symptom severity which correlates with higher dose of such treatment in the season when symptoms are worse, comprising:
supplying the model with data points including point in time, dose, and patient status, such status most conveniently having three options, those three options being over dosed, under dosed, and properly dosed, the latter meaning that the patient has a remarkable feeling of wellness with respect to the disorder;
calibrating the model, wherein if enough data points indicate properly dosed then that is the only option needed for calibration, wherein if not, then it is sufficient to have enough data points which include two of the three options; and
using the calibrated model to calculate an optimal treatment dose for the point in time of interest.

3. The method of claim 2 in which the model is the Empirical model and in which the medical disorder is a psychiatric disorder and in which the treatment is a psychoactive drug.

4. The method of claim 2 in which the model is the Empirical model and in which the disorder is a bipolar disorder and in which the treatment is a drug given for bipolar disorder.

5. The method of claim 2 in which the model is the Empirical model and in which the disorder is a major depressive disorder which is worse in spring/summer and in which the treatment is an antidepressant drug.

6. The method of claim 2 in which the model is the Empirical model and in which the disorder is a major depressive disorder which is worse in fall/winter and in which the treatment is an antidepressant drug.

7. The method of claim 3 in which the calibration is performed using the flat-line method.

8. The method of claim 3 in which the calibration is performed using the flat-line method and the two-stair-step method.

9. The method of claim 3 in which the calibration is performed using the peak-and-trough method.

10. A model-based method for estimating an optimal treatment dose for any point in time, for a case of major depressive disorder with seasonal pattern in which the treatment is an anti-depressive drug, comprising:
supplying the Theoretical model with data points including point in time, dose, and patient status, such status most conveniently having three options, those three options being over dosed, under dosed, and properly dosed, the latter meaning that the patient has a remarkable feeling of wellness with respect to the disorder;
calibrating the model using the general method, wherein if enough data points indicate properly dosed then that is the only option needed for calibration, and wherein if not, then it is sufficient to have enough data points which include two of the three options; and
using the calibrated model to calculate an optimal treatment dose for the point in time of interest.

11. The method of claim 1 in which the model is a theoretical model based on prorating optimal dose by day length, and for which such case has a seasonal aspect which is also related to current light exposure or history of light exposure, and for which such case has a decrease in symptom severity which correlates with higher dose of such treatment in the season when symptoms are worse, and in which the steps comprise:
supplying the model with data points including point in time, dose, and patient status, such status most conveniently having three options, those three options being over dosed, under dosed, and properly dosed, the latter meaning that the patient has a remarkable feeling of wellness with respect to the disorder;
calibrating the model, wherein if enough data points indicate properly dosed then that is the only option needed for calibration, and wherein if not, then it is sufficient to have enough data points which include two of the three options; and
using the calibrated model to calculate an optimal treatment dose for the point in time of interest.

12. The method of claim 11 in which the model is the Theoretical model and in which the medical disorder is a psychiatric disorder and in which the treatment is a psychoactive drug.

13. The method of claim 11 in which the model is the Theoretical model and in which the disorder is a bipolar disorder and in which the treatment is a drug given for bipolar disorder.

14. The method of claim 11 in which the model is the Theoretical model and in which the disorder is a major depressive disorder which is worse in spring/summer and in which the treatment is an antidepressant drug.

15. The method of claim 11 in which the model is the Theoretical model and in which the disorder is a major depressive disorder which is worse in fall/winter and in which the treatment is an antidepressant drug.

16. The method of claim 15 in which the calibration is performed using the general method.

17. The method of claim 15 in which the calibration is performed using the high-low method.

18. The method of claim 15 in which the calibration is performed using the dose-daylength

19. The method of claim 15 in which the calibration is performed using the dose-daylength method in combination with using the two-stair-step method to obtain properly dosed data points for the best-fit line within the dose-daylength method.
